(19) United States
(12) Patent Application Publication
(10) Pub. No.: US 2025/0223063 A1
(43) Pub. Date: Jul. 10, 2025

(54) Box Closing Apparatus, Box Tab and Panel Closer, and Method

(71) Applicant: MGM Manufacturing LLC, Post Falls, ID (US)

(72) Inventor: Matthew Garrett Mahnke, Post Falls, ID (US)

(73) Assignee: MGM Manufacturing LLC, Post Falls, ID (US)

(21) Appl. No.: 18/408,298

(22) Filed: Jan. 9, 2024

(51) Int. Cl. B65B 7/20; B31B 50/00

(52) U.S. Cl. CPC B65B 7/20; B31B 50/004

(57) ABSTRACT

A box tab and panel folding and closing apparatus is provided having a tab and panel guide member and a tab hold down member. The tab and panel guide member has a first tab progressively curved guide surface, a panel progressively curved guide surface provided at least in part downstream of the tab progressively curved guide surface, and a second tab progressively curved guide surface downstream of the first tab progressively curved guide surface. The tab hold down member and the tab progressively curved guide surface provide a tab guide slot configured to progressively urge the box tab to fold relative to a contiguous box panel. The panel progressively curved guide surface urges the box panel angularly into a closing position while tucking the contiguous tab in an open end of the box by engaging the tab against the second tab progressively curved guide surface. A method is also provided.

### TECHNICAL FIELD

The technical field is generally related to the field of boxing and packaging of goods. More particularly, the present technical field pertains to the folding and closing of tabs and flaps into the open ends of boxes.

### BACKGROUND

It was previously known to close ends on boxes and packages with an array of stationary and/or moving guide bars that progressively bend, fold and tuck end panels and flaps on boxing machines. Use of boxes has increased across a broad range of industries as warehousing and home delivery has overtaken local shopping and distribution for many forms of merchandise. Complex arrangements of guide bars and/or rollers successively placed in series along a boxing conveyor path can complicate factory maintenance and cleaning and can increase a need for maintenance requiring adjustment and alignment periodically. Moving parts on such arrangements often necessitate use of lubrication and low friction contact members. Lubrication might generate concerns in several exemplary industries including food packaging, pharmaceutical packaging, and ammunition packaging. Even for the case of food packaging, use of peanut oil to lubricate rollers can lead to concerns over allergen contamination for some end product users. Secondly, moving parts increase maintenance and can cause concern over dislodged or loose parts contaminating a packaging product. Accordingly, improvements are needed to mechanisms for closing box ends on a boxing machine that overcome such concerns.

### SUMMARY

A box closer block is provided for a boxing apparatus and method. More particularly, a closer block is provide having no moving parts which eases maintenance and increases reliability. The closer block closes tabs and panels on open ends of reverse tuck (RT) and straight tuck (ST) boxes, as wells as other forms of boxes having contiguous tabs and panels that fold relative to one another before being tucked and closed into an open end of a box.

According to one aspect, a box tab and panel folding and closing apparatus is provided having a tab and panel guide member and a tab hold down member. The tab and panel guide member has a first tab progressively curved guide surface, a panel progressively curved guide surface provided at least in part downstream of the tab progressively curved guide surface, and a second tab progressively curved guide surface downstream of the first tab progressively curved guide surface. The tab hold down member is carried relative to the tab and panel guide member and has a guide surface substantially parallel to the panel as the panel enters the apparatus spaced and proximate a guide surface of the tab and panel guide member to define a panel guide slot. The tab hold down member further cooperates with the tab progressively curved guide surface to provide a tab guide slot configured to progressively urge the box tab to fold relative to a contiguous box panel. The panel progressively curved guide surface is configured to progressively urge the box panel angularly into a closing position while tucking the contiguous tab in an open end of the box by engaging the tab against the second tab progressively curved guide surface.

According to another aspect, a tuck box closer is provided having a tab and panel guide member and a tab hold down member. The tab and panel guide member has an outer progressively curved tab guide surface configured to bend a tab relative to a contiguous panel on a box end, a progressively curved panel closing guide surface downstream at least in part from the slot, and a progressively curved tab tuck guide surface. The tab hold down member is supported spaced from the outer progressively curved tab guide surface to define a slot between the tab hold down member and the outer progressively curved tab guide surface. The tab hold down member is further spaced from an adjacent horizontal panel guide surface on the tab and panel guide member adjacent the slot configured to retain each box panel horizontally while the slot bends the respective tab upwardly along the tab guide surface.

According to yet another aspect, a method is provided for closing panels on a box.

### BRIEF DESCRIPTION OF THE DRAWINGS

FIG. 1 is a perspective view from above and upstream of a box closer panel block and conveyor system in operation according to one aspect.

FIG. 2 is an enlarged perspective view from above and upstream of the box closer panel block of FIG. 1.

FIG. 3 is an exploded perspective view from above and upstream of the box closer panel block of FIG. 2.

FIG. 4 is an exploded perspective view of the right side lower guide, upper guide, and hold down of FIG. 3.

FIG. 5 is an upstream end view of the right side components of FIG. 4.

FIG. 6 is a left side view of the components of FIG. 5.

FIG. 7 is a perspective view illustration of six successive folding steps of a series of conveyed boxes moving through the box closer panel block of FIG. 1.

FIG. 8 is a perspective view from above and upstream of the box closer panel block showing a first folding step, S1, depicted in FIG. 7.

FIG. 9 is a perspective view from above and upstream of the box closer panel block showing a second folding step, S2, depicted in FIG. 7.

FIG. 10 is a perspective view from above and upstream of the box closer panel block showing a third folding step, S3, depicted in FIG. 7.

FIG. 11 is a perspective view from above and upstream of the box closer panel block showing a fourth folding step, S4, depicted in FIG. 7.

FIG. 12 is a perspective view from above and upstream of the box closer panel block showing a fifth folding step, S5, depicted in FIG. 7.

FIG. 13 is a perspective view from above and upstream of the box closer panel block showing a sixth folding step, S6, depicted in FIG. 7.

FIG. 14 is a perspective view from above and upstream of the box closer panel block with left side portions of FIG. 4 removed to facilitate viewing of folding steps.

FIG. 15 is a perspective view from above and upstream of the box closer panel block of FIG. 14, but later in time, with left side portions of FIG. 4 removed to facilitate viewing of folding steps.

FIG. 16 is a plan view from above of the box closer panel block of FIG. 15.

FIG. 17 is a perspective view from above and upstream of the right upper guide with the right upper hold down removed.

FIG. 18 is a perspective view from above and upstream of the right upper guide and the right upper hold down.

FIG. 19 is a plan view from above of the box closer panel block before entry of any boxes.

FIGS. 19A through 19G are corresponding vertical sectional views of FIG. 17.

FIG. 20 is a plan view from above of the box closer panel block as a first box enters.

FIGS. 20A through 20G are corresponding vertical sectional views of FIG. 20.

FIG. 21 is a plan view from above of the box closer panel block as tabs are folded relative to each panel.

FIGS. 21A through 21G are corresponding vertical sectional views of FIG. 21.

FIG. 22 is a plan view from above of the box closer panel block 10 as the folded tabs and panels are further closed prior to tucking.

FIGS. 22A through 22G are corresponding vertical sectional views of FIG. 22.

FIG. 23 is a plan view from above of the box closer panel block as the folded tabs and panels are tucked into the box ends.

FIGS. 23A through 23G are corresponding vertical sectional views of FIG. 23.

FIG. 24 is a plan view from above of the box closer panel block as the tucked tabs and panels are further compressed and inserted into the box.

FIGS. 24A through 24G are corresponding vertical sectional views of FIG. 24.

FIG. 25 is a plan view from above of the box closer panel block as the completed box exits the box closer panel block.

FIGS. 25A through 25G are corresponding vertical sectional views of FIG. 25.

FIG. 26 is a perspective view from above and upstream of an alternate box closer panel block and conveyor system in operation according to another aspect.

### DETAILED DESCRIPTION OF THE ILLUSTRATED EMBODIMENTS

This disclosure of the invention is submitted in furtherance of the constitutional purposes of the U.S. Patent Laws “to promote the progress of science and useful arts” (Article 1, Section 8).

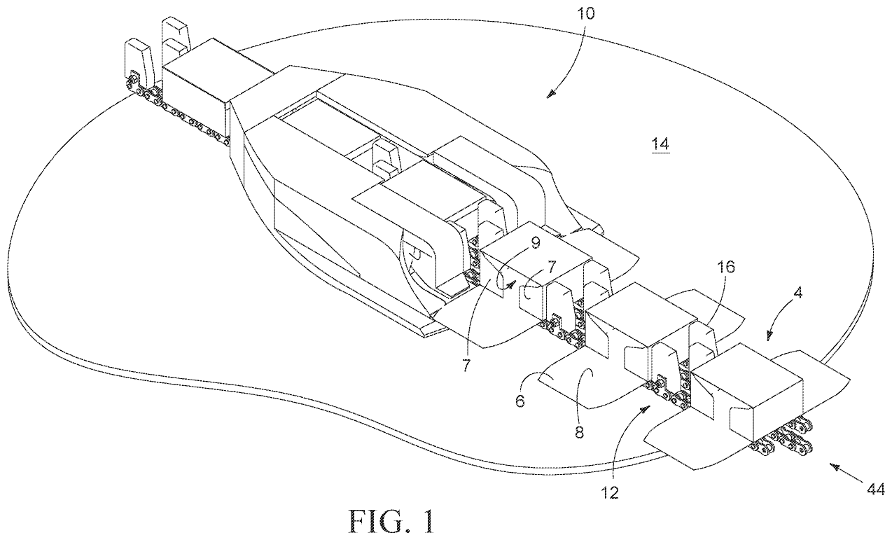

FIG. 1 is a perspective view from above and upstream of a box closer panel block, or closer 10 and conveyor system 12 mounted onto a machine table top 14 in operation according one aspect for closing a sequential array of box ends. More particularly, individual boxes 4 are loaded sequentially onto a conveyor system 12 comprising a conveyor chain having spaced apart pairs of adjacent pawls 16 between which individual opened boxes have been deposited for conveyance along a delivery path 44 by a vacuum pick machine (not shown). Such boxes 4 are shown as straight tuck (ST) boxes, one of the most common types of boxes used in a variety of industries including ammunition packaging. Optionally, reverse tuck (RT) boxes can be used with the box closer panel block 110 (of FIG. 26). Further optionally, other types of boxes having similar folded ends, or panels with tabs can be used. Both straight tuck (ST) and reverse tuck (RT) boxes have open opposed ends 9 with a closing tuck on each end comprising a panel 8 and a contiguously formed end tab 6 that depends on a hinge line from the panel. Such end tabs can be formed with or without slit locks and side fold tabs 7 that are formed to fold in a perpendicular direction relative to tab 6 and panel 8.

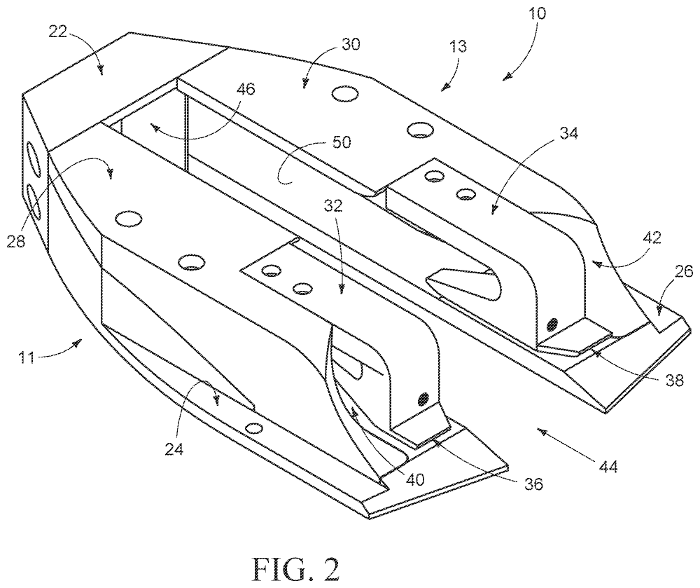

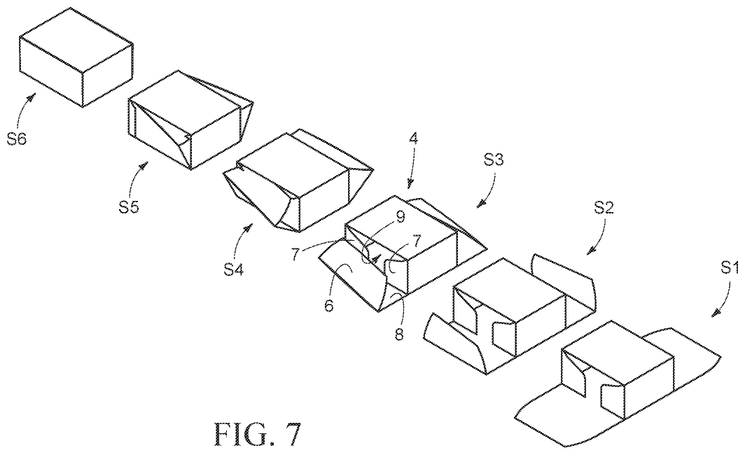

FIG. 2 is an enlarged perspective view from above and upstream of the box closer panel block 10 of FIG. 1. More particularly, a straight tuck (ST) box (see FIG. 1) is guided along path 44 by a conveyor such that opposed ends of each box are guided into respective panel hold down slots 36 and 38 along an upstream end of block 10 moving towards a downstream end to exit through a final closer exit block, or closer 22 via a closer exit aperture 46. A left tab and panel guide member 11 is formed by left lower guide block, or member 24 and left upper guide block, or member 28. A right tab and panel guide member 13 is formed by right lower guide block, or member 26 and right upper guide block, or member 30. A left tab slot 40 and a right tab slot 42 each receive a respective tab on each box so as to impart a bend, or fold line between each panel and tab, typically along a preformed fold line between the tab and the panel. Further folding details are provided below with reference to FIGS. 7-16 and 19-25.

As shown in FIG. 2, left and right hold down arms, or appendages 32 and 34 are carried or mounted onto respective left and right upper guides 28 and 30 so as to define left and right tab slots, or tab bending slots 40 and 42. Left and right upper guides 28 and 30 are likewise carried or mounted onto respective left and right lower guides 24 and 26. Threaded fasteners, such as hex head cap screws are used to secure together adjacent components of box closer panel block 10, as well as to secure to block 10 onto machine bed, or table 14 (see FIG. 1). Optionally, block 10 can be constructed from a monolithic piece of material, such as a 3D printed plastic or metal material.

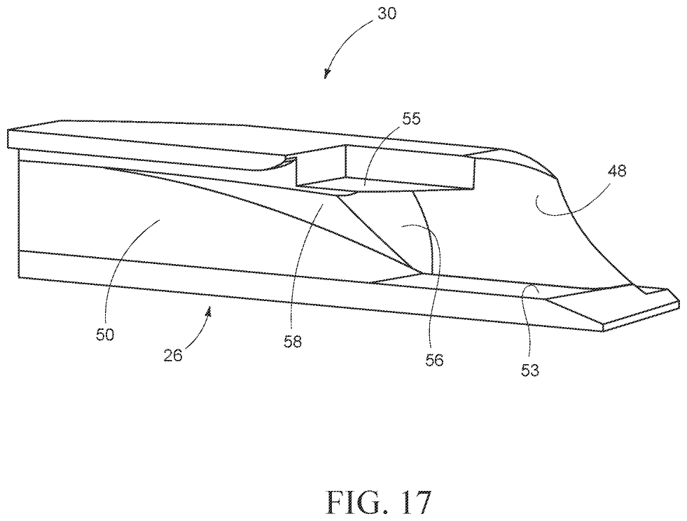

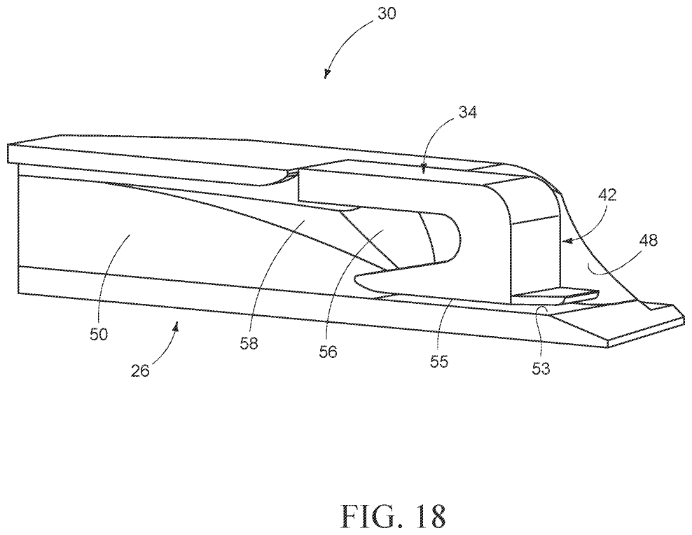

According to one construction depicted in FIG. 2, surfaces 48, 50, inner surfaces of exit 46 and surfaces 56 and 58 (see FIG. 17) and surfaces 53 and 55 (see FIG. 18), along with any other surfaces that contact a box, are polished metal surfaces. Optionally or additionally, a low friction coating surface can be applied to any one or more of such surfaces including Polytetrafluorethylene PTFE), ceramic, or other suitable low friction hardened surfaces, or such surfaces can be hard anodized.

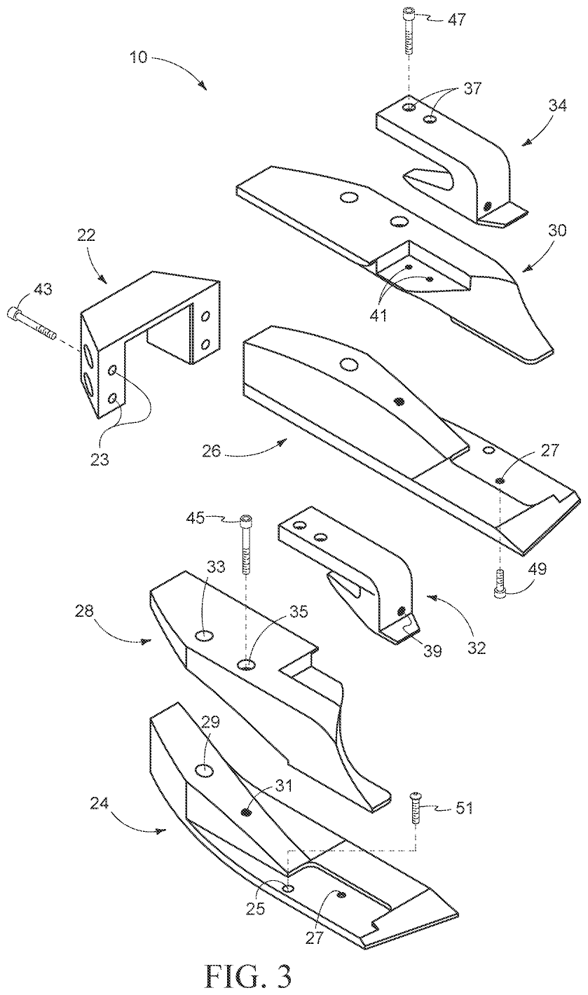

FIG. 3 is an exploded perspective view from above and upstream of the box closer panel block 10 of FIG. 2. Block 10 has an exit end final closer block 22 that secures together left and right sides of block 10 with two pairs of fasteners 43. A left pair of fasteners 43 each extend through a respective compound bore 23 into a left lower guide block 24 and into complementary threaded bores (not shown). Likewise, a right pair of fasteners 43 each extend through a counterbore, or compound bore 23 into a right lower guide block 26 into complementary threaded bores (not shown). Left and right upper guide blocks, or members 28 and 30 are likewise affixed atop lower guide blocks, or members 24 and 26 with threaded fasteners (not shown) through step down bore 35 and into complementary threaded bore 31. Additionally, another threaded fastener 49 is received through a stepped down threaded bore 27 in a bottom of each lower guide block 24 and 26 into a complementary threaded bore (not shown) on an underside of upper guide blocks 28 and 30. Clearance bores 29 and 33 in lower guide blocks 24 and 26 and upper guide blocks 28 and 30 are provided for affixing optional mounting configurations to box closer panel block 10 on an alternative mounting configuration (not shown). Each hold down arm, or block 32 and 34 is secured with threaded fasteners 47 atop each respective upper guide block 28 and 30, such as threaded fasteners 47 that pass through stepped down bores 37 in block 34 and into complementary threaded bores 41 in upper guide block 30. Finally, a machine screw 51 is received through a clearance bore 25 in left lower guide block 24, as well as right lower guide block 26 (not shown) and into corresponding complementary threaded bores provided in a machine top, or table to which block 10 is affixed.

Although FIG. 3 is shown as an assembly of metal, or aluminum material blocks, it is understood that box closer panel block 10 can be constructed from a unitary piece of material, such as a machined block or a 3D printed block. Furthermore, it is understood that block 10 can alternatively be constructed from any metal, such as stainless steel, steel, bronze, or other alloys, and any plastic or composite material.

As shown in FIG. 3, screws 43 and 45 are each ¼-20 UNC (English) socket head cap screws, according to one construction. Cap screws 43 connect the final closer 22 to both of the lower guides 24 and 26, thereby securing them together. Screws 47 are 8-32 UNC (English) socket head cap screws, according to one construction. Screws 49 are 10-32 UNC (English) socket head cap screws, according to one construction. Screws 51 are ¼-20 UNC (English) rounded hex head screws, according to one construction. Other forms of fasteners can be used including bolts and nuts, machine screws, or any other suitable form of fastener. Further optionally, Individual blocks, or components forming block 10 can be welded together, adhesively affixed together, or formed from any suitable structural material from a unitary piece of material, either by machining or 3D printing.

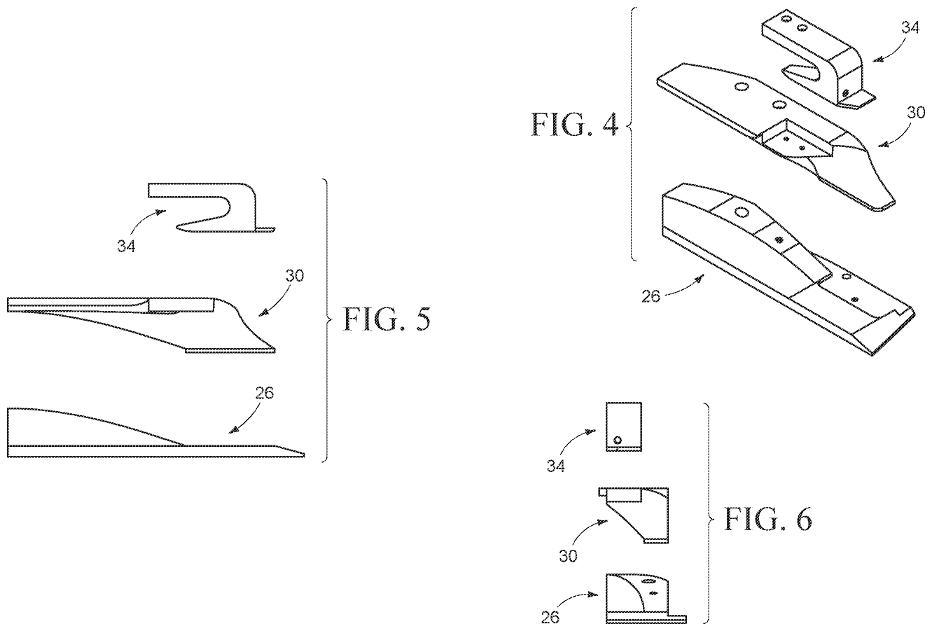

FIG. 4 is an exploded perspective view of the right side lower guide member 26, upper guide member 30, and hold down finger 34 of FIG. 3.

FIG. 5 is an upstream end view of the right side components of FIG. 4 further illustrating members 26, 30 and 34 in the same exploded view, but in such end view.

FIG. 6 is a left side view of the components of FIG. 5 further illustrating members 26, 30 and 34 in such side view.

FIG. 7 is a perspective view illustration of six successive folding steps, Steps “S1” through “S6” of a single box moving through the box closer panel block of FIG. 1. More particularly, a straight tuck (ST) box is shown being conveyed in stages through the box closer panel block 10 in FIGS. 8-13 so as to fold and tuck a tab 6 and a contiguous flap, or panel 8 on each open lateral end of opened box 4. In operation, it is understood that a series of boxes move through such folding steps in a successive manner as depicted below with reference to FIGS. 8-13. In this process, it is understood that box closer panel block 10 is stationary and has no moving parts. Instead, individual boxes are moved in series through block 10 in a manner that folds each tab relative to the depending panel, and tucks and closes the tab and panel into an open end, or side of box 4.

FIG. 8 is a perspective view from above and upstream of the box closer panel block 10 showing a first folding step, S1, depicted in FIG. 7. Each tab 6 and panel 8 enters on opposed sides of block 10 to begin a folding and tucking process. As shown and numbered, left tab 6 and panel 8 on box 4 are shown with panel 8 just prior to entering left side guide panel slot 36 and tab 6 entering left tab folding slot 40. Box 4 is being intermittently moved, or conveyed in discrete amounts into and through block 10 during such folding and tucking operation. Optionally, box 4 can be moved through block 10 in a continuous conveying operation.

FIG. 9 is a perspective view from above and upstream of the box closer panel block 10 showing a second folding step, S2, depicted in FIG. 7. More particularly, tab 6 is shown folded to a nearly 90 degree angle relative to panel 8, on each end, as tab 6 passes through slot 40 and panel 8 passes through slot 36. As tab 6 and panel 8 are moved downstream along conveyor delivery path 44, tab 6 is progressively folded relative to panel 8 and folded tab 6 and panel 8 are further reoriented in slots 36 and 40 to tuck tab 6 into an open side or end of box 4 where tab 6 is inserted during a closing operation.

FIG. 10 is a perspective view from above and upstream of the box closer panel block 10 showing a third folding step, S3, depicted in FIG. 7. More particularly, box 4 is shown in a further downstream position than in FIG. 9 with tab 6 folded relative to panel 8 greater than 90 degrees and panel 8 starting to rotate from horizontal such that tab 6 tucks within relief slot 52 in left hold down arm 32. Left upper guide member, or block 28 has been removed to facilitate viewing. Left tab folding slot 40 is further shown with guide surface 48 removed along with removed block 28 to facilitate further viewing of slot 40. Surface 48 is constructed as a straight line perpendicular to the axis of travel for box 4 and such line is rotated to form a helical surface 48 along the travel direction. Optionally, surface 48 can be a concave or convex curved surface, or a discretized element surface of small plates, or flat surfaces joined together.

FIG. 11 is a perspective view from above and upstream of the box closer panel block 10 showing a fourth folding step, S4, depicted in FIG. 7. More particularly, box 4 is shown in a further downstream position than in FIG. 10 with tab 6 being inserted along a downstream portion into an open end of box 4. A helical surface 50 engages with panel 8 moving in a downstream direction to raise panel 8 and facilitate tucking of tab 6 into box 4. Surface 50 is constructed as a straight line perpendicular to the axis of travel for box 4, similar to surface 48, and such line is rotated to form a helical surface 50 along the travel direction. Optionally, surface 50 can be a concave or convex curved surface, or a discretized element surface of small plates, or flat surfaces joined together.

FIG. 12 is a perspective view from above and upstream of the box closer panel block 10 showing a fifth folding step, S5, depicted in FIG. 7. More particularly, left and right helical surfaces 50 cooperate to further urge panel 8 and tab 6 on both left and right sides of box 4 to be fully inserted into box 4 as box 4 moves to a downstream end of block 10. A transition between surfaces 48 and 50 is shown below in greater detail with reference to FIG. 17.

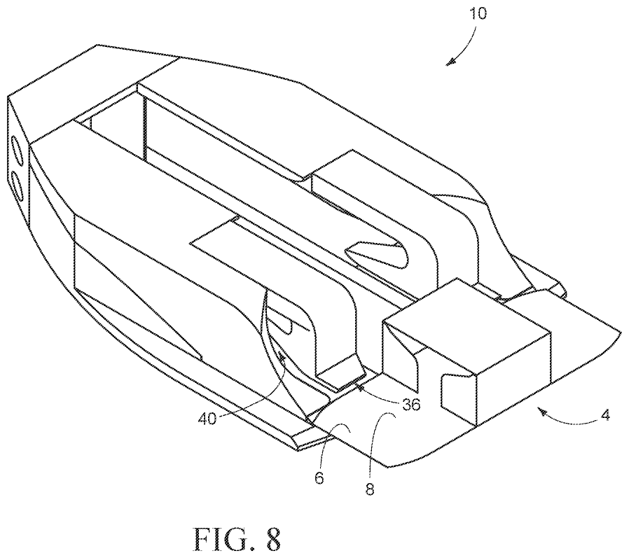

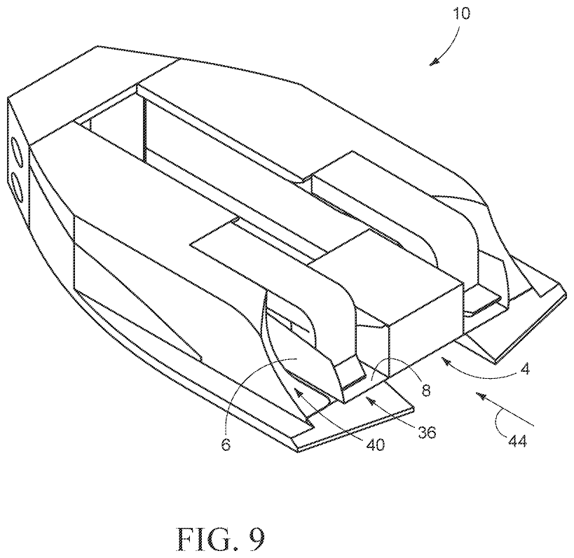

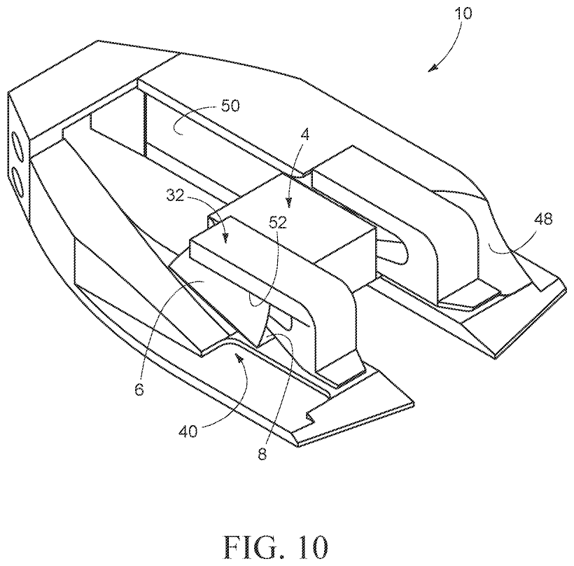

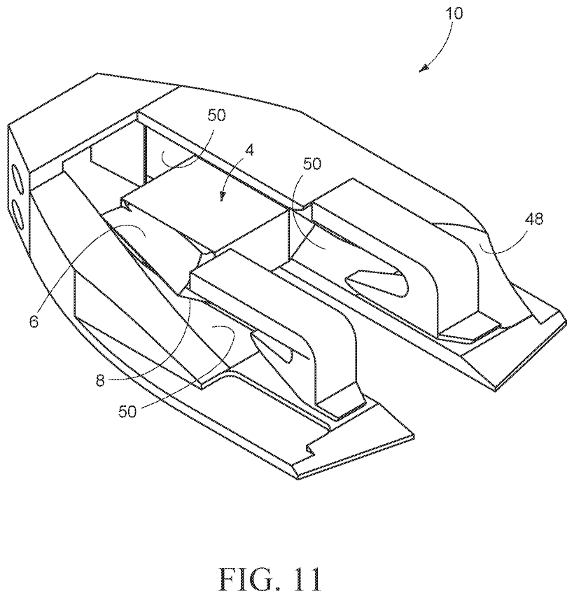

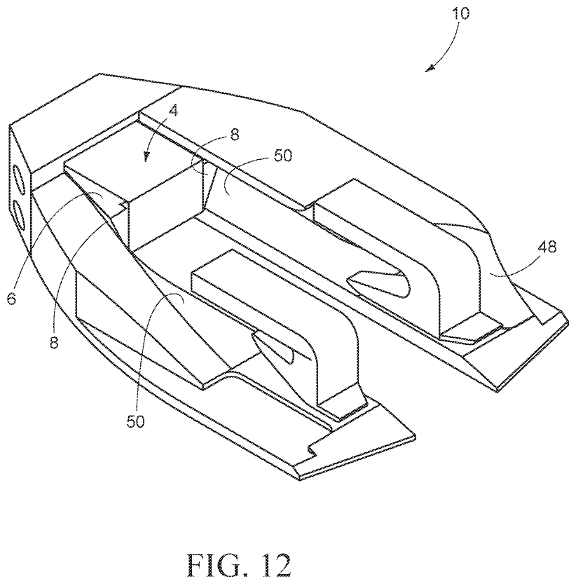

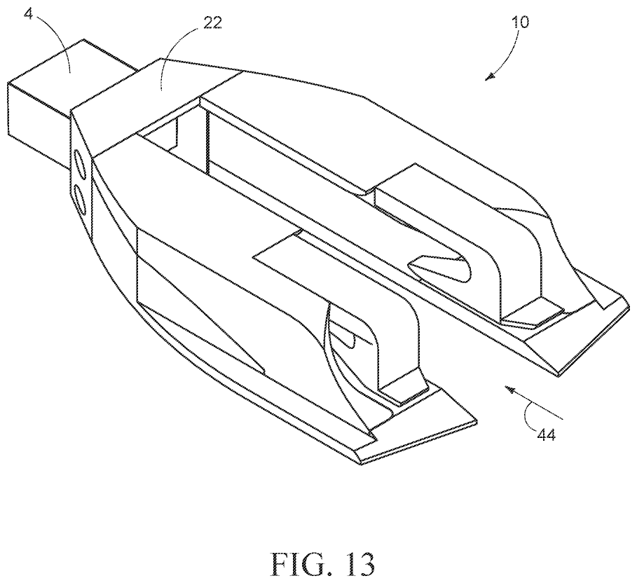

FIG. 13 is a perspective view from above and upstream of the box closer panel block 10 showing a sixth folding step, S6, depicted in FIG. 7. More particularly, box 4 is shown exiting block 10 at a downstream end along path 44 after passing through final closer block 22 which further squeezes opposed ends of box 4 to finalizing closing of both ends.

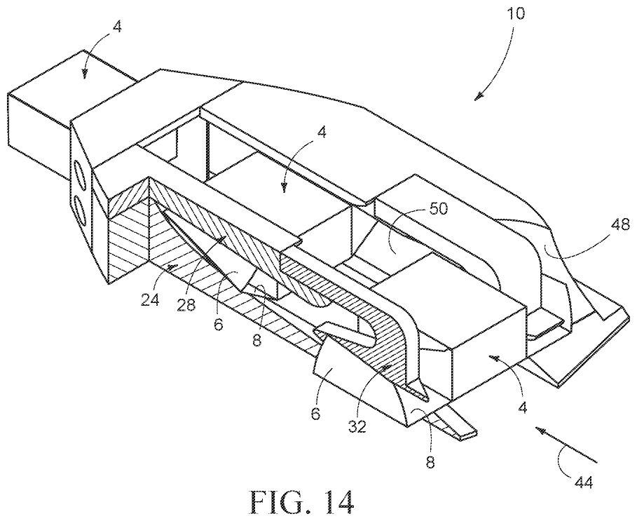

FIG. 14 is a perspective view from above and upstream of the box closer panel block 10 with left side portions of FIG. 14 removed to facilitate viewing of folding steps and showing a single of box 4 being conveyed through block 10 at three different positions and points in time. More particularly, tab 6 and panel 8 are shown more clearly in breakaway relative to left hold down arm 32 on the first position of box 4 as box 4 moves into guide surface 48 (removed) starting along conveyor path 44. The second downstream position of box 4, later in time than the first shown position, shows tab 6 and panel 8 being raised by guide surface 50 (see opposite side for reference numeral) of lower guide block 24. Tab 6 is further progressively folded downward by an underside helical surface 58 (see FIG. 17) of left upper guide block 28.

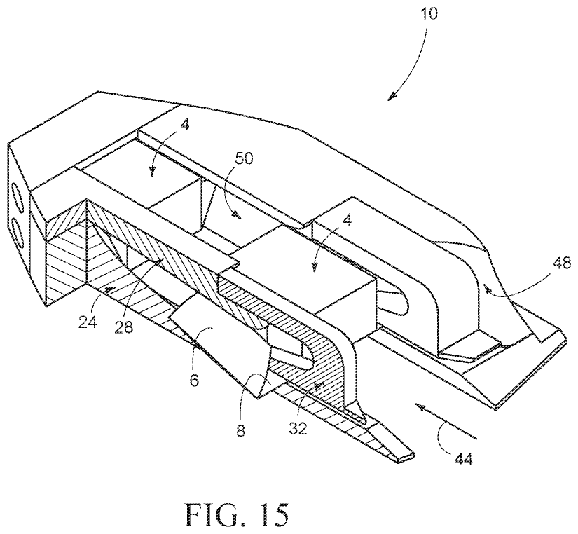

FIG. 15 is a perspective view from above and upstream of the box closer panel block 10 of FIG. 14, but later in time than FIG. 14, with left side portions of FIG. 4 removed to facilitate viewing of folding steps. More particularly, tab 6 and panel 8 are shown more clearly in breakaway relative to left hold down arm 32 on the first position of box 4 as box 4 moves along conveyor path 44 further downstream between surfaces 48, 56 (see FIG. 17), 58 (see FIG. 17) and 50 to further fold and close tab 6 and panel 8 into box 4. Downstream position of box 4, later in time, is shown nearly completely closed before exiting a downstream end of block 10. A bottom surface 58 (see FIG. 17) of left upper guide block 28 is shown initiating tucking and further folding of tab 6 relative to panel 8 after passing downstream of left hold down arm 32. Lower block 24, upper block 28 and hold down arm 32 are shown in partial vertical breakaway to facilitate viewing of box 4 as it passes downstream through block 10.

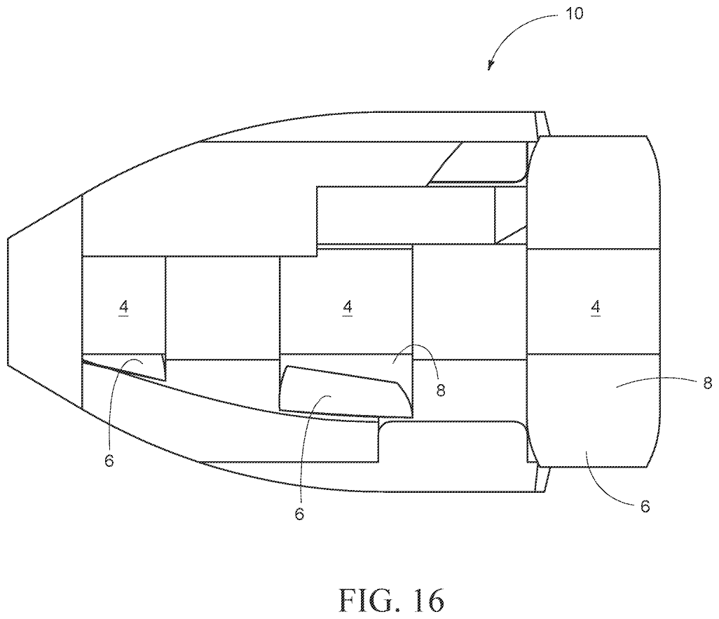

FIG. 16 is a plan view from above of the box closer panel block 10 of FIG. 15. A single box is shown in three distinct positions at different points in time as box 4 is moved downstream through block 10. In a shown first upstream position, box 4 has tabs 6 and panels 8 in a horizontal and unfolded configuration while beginning to enter block 10. A second midstream position of box 4 shows a left tab 6 and panel 8 folded and partially tucked. A downstream position of box 4 shows a tab 6 being further and more completely tucked into box 4 by block 10.

FIG. 17 is a perspective view from above and upstream of the right upper guide block 30 and the right lower guide block 26 with the right upper hold down removed and showing a mounting recess 55 used to affix the right upper hold down. Helical guide surface 48 transitions through tab/panel transitional guide surface 56 and tab underside helical guide surface 58 into panel helical guide surface 50. Tab/panel transitional guide surface 56 moves a panel that was held horizontal along surface 53 (by omitted surface 55 on arm 34, see FIG. 18) such that the tab and panel are rotated upwardly so that the tab is further rotated downstream by helical guide surface 58 and helical surface 50 of lower guide member 26 continues downstream to rotate the panel into a vertical orientation.

FIG. 18 is a perspective view from above and upstream of the right upper guide block 30, the right lower guide block 26, and the right upper hold down arm 34 affixed to block 30. Horizontal surface 55 cooperates with horizontal surface 53 to hold a box panel horizontal while helical surface 48 folds a depending tab (not shown) along a fold line as a panel and tab move downstream between arm 34, lower guide member 26, and upper guide member 30. The progressively transitioning surfaces 48, 56, 58 and 50 can be seen relative to arm 34, lower guide block 26, and upper guide block 30. Arm 34 cooperates with surface 42 to provide right tab slot 42.

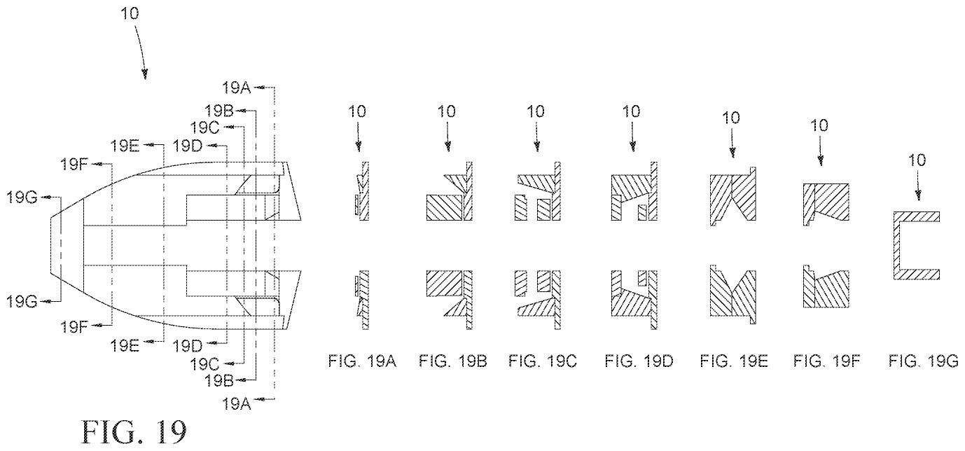

FIG. 19 is a plan view from above of the box closer panel block 10 before entry of any boxes. FIGS. 19A through 19G show corresponding vertical sectional views along block 10.

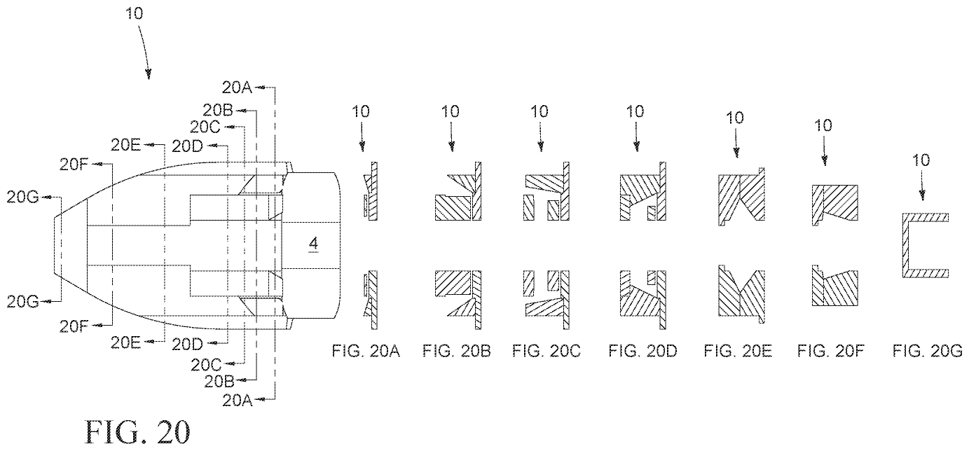

FIG. 20 is a plan view from above of the box closer panel block 10 as a first box 4 begins to enter block 10 from an upstream end. FIGS. 19A through 19G show corresponding vertical sectional views of FIG. 20 along block 10.

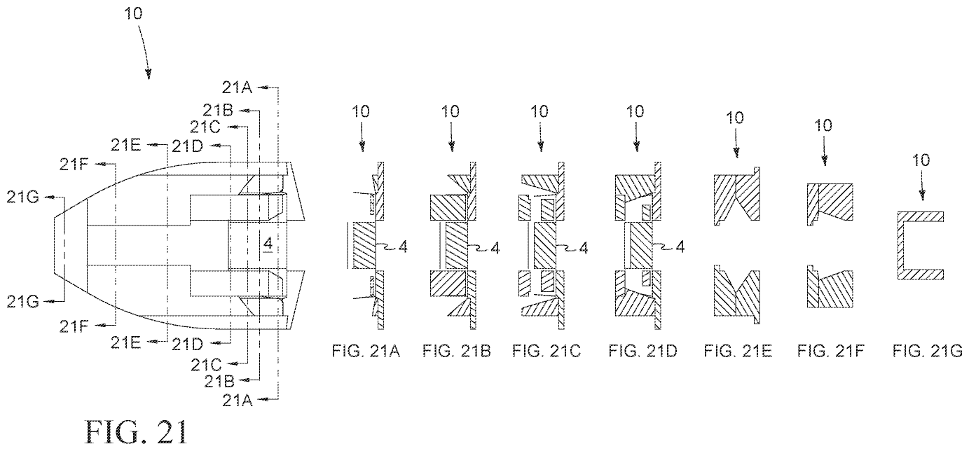

FIG. 21 is a plan view from above of the box closer panel block 10 as tabs are folded relative to each panel and FIGS. 21A through 21G are corresponding vertical sectional views of FIG. 21 along block 10. Box 4 is shown in FIGS. 21A through 21D.

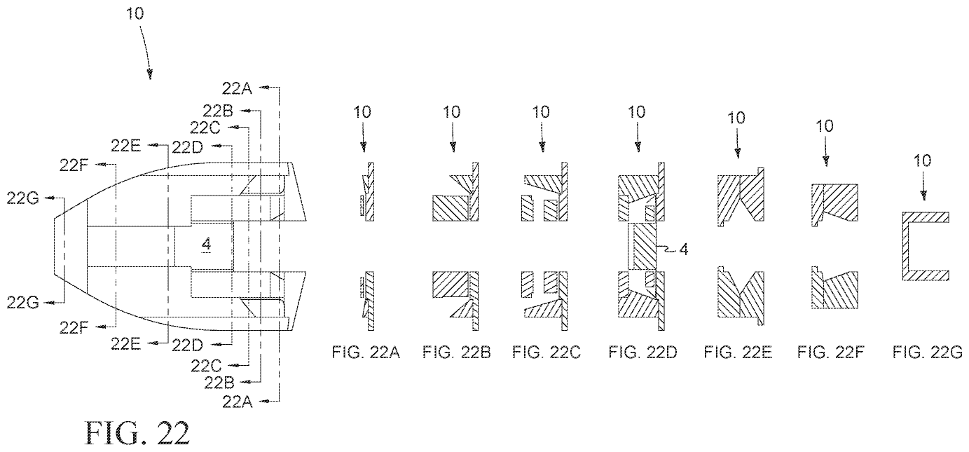

FIG. 22 is a plan view from above of the box closer panel block 10 as the folded tabs and panels are further closed prior to tucking. FIGS. 22A through 22G show corresponding vertical sectional views of FIG. 22. Box 4 is shown in FIG. 22D.

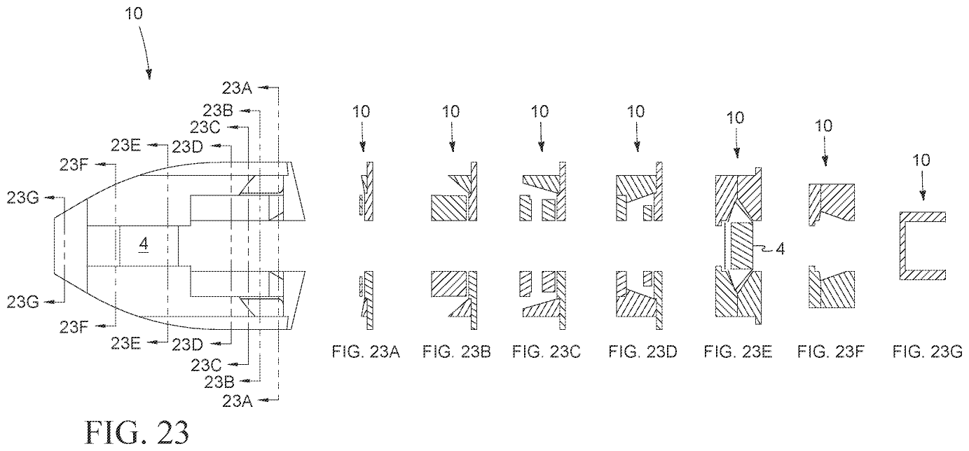

FIG. 23 is a plan view from above of the box closer panel block 10 as the folded tabs and panels are tucked into the ends of box 4. FIGS. 23A through 23G show corresponding vertical sectional views of FIG. 23. Box 4 is shown in FIG. 23E.

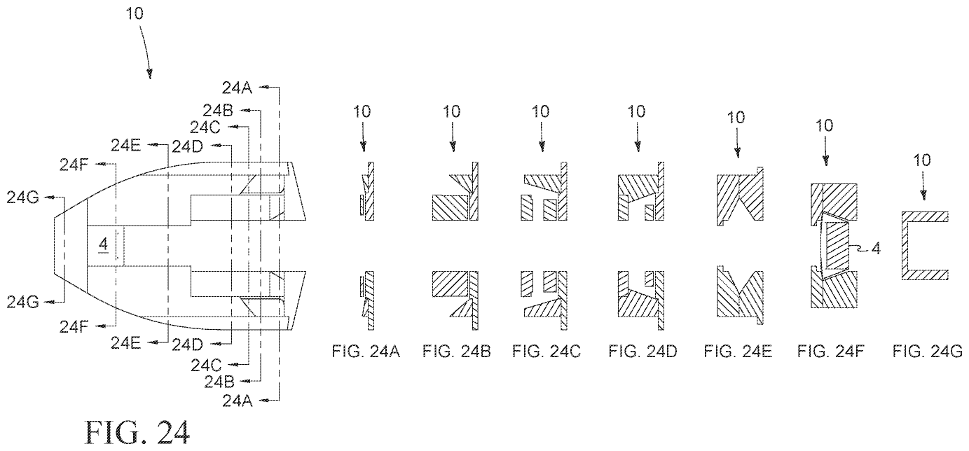

FIG. 24 is a plan view from above of the box closer panel block 10 as the tucked tabs and panels are further compressed and inserted into the box 4. FIGS. 24AA through 24GG show corresponding vertical sectional views of FIG. 24. Box 4 is shown in FIG. 24F.

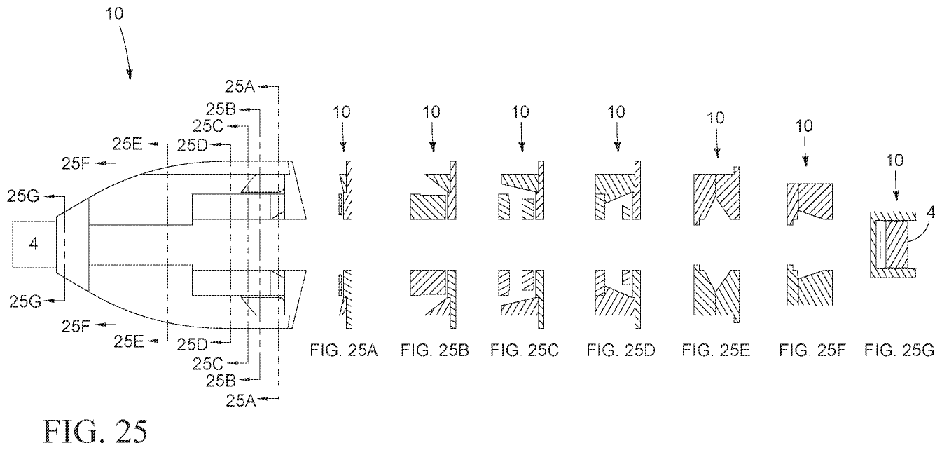

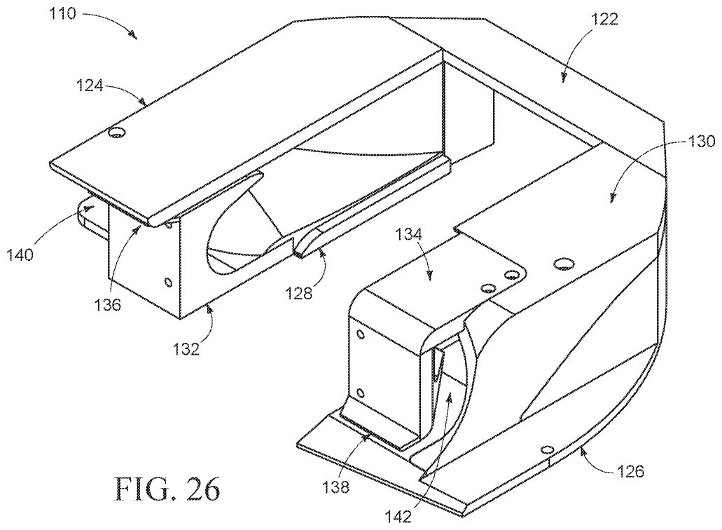

FIG. 25 is a plan view from above of the box closer panel block 10 as the completed box 4 exits the box closer panel block. FIGS. 25A through 25G show corresponding vertical sectional views of FIG. 25. Box 4 is shown in FIG. 25G.

FIGS. 25AA through 25GG are corresponding vertical sectional views of FIG. 25.

FIG. 26 is a perspective view from above and upstream of an alternate box closer panel block 110 usable with a conveyor system in operation according to another aspect. More particularly, box closer panel block 110 is configured for use with reverse tuck (RT) boxes that have open opposed ends with a closing tuck on each end comprising a panel and a contiguously formed end tab, but one is on the top and another is on the bottom, that depends on a hinge line from the panel. Such end tabs can be formed with or without slit locks and side fold tabs that are formed to fold on a perpendicular direction to the tab and the panel. A left side panel hold down slot 136 is provided on block 110 along a top portion for a top mounted tab and panel, and a right side panel hold down slot 138 is provided along a bottom portion for a bottom mounted tab and panel. Likewise, left tab folding slot 140 is upside down relative to right tab folding slot 142.

Although both box closer blocks 10 and 110 of FIGS. 1-25 and 26, respectively, are shown mounted in a horizontal plane configuration such that box panels and tabs, prior to folding, are also in such horizontal plane, it is understood that blocks 10 and 110 can be supported in any orientation during operation. For example, a conveyor can place such blocks in a vertical plane with box grippers or clamps holding conveyed blocks as they pass through a block in order to fold the tabs relative to the flaps, and fold and tuck each tab and flap into an open end (or side) of each conveyed box. Likewise, any angular orientation can be provided for such blocks.

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

In compliance with the statute, the subject matter disclosed herein has been described in language more or less specific as to structural and methodical features. It is to be understood, however, that the claims are not limited to the specific features shown and described, since the means herein disclosed comprise example embodiments. The claims are thus to be afforded full scope as literally worded, and to be appropriately interpreted in accordance with the doctrine of equivalents.

I/We claim:

1. A box tab and panel folding and closing apparatus, comprising:
a tab and panel guide member having a first tab progressively curved guide surface, a panel progressively curved guide surface provided at least in part downstream of the tab progressively curved guide surface, and a second tab progressively curved guide surface downstream of the first tab progressively curved guide surface; and
a tab hold down member carried relative to the tab and panel guide member having a guide surface substantially parallel to the panel as the panel enters the apparatus spaced and proximate a guide surface of the tab and panel guide member to define a panel guide slot, the tab hold down member further cooperating with the tab progressively curved guide surface to provide a tab guide slot configured to progressively urge the box tab to fold relative to a contiguous box panel, the panel progressively curved guide surface configured to progressively urge the box panel angularly into a closing position while tucking the contiguous tab in an open end of the box by engaging the tab against the second tab progressively curved guide surface.

2. The box tab and panel folding and closing machine of claim 1, wherein a pair of left and right tab and panel guide members and tab hold down members are provided spaced apart to close opposed ends of a box.

3. The box tab and panel folding and closing machine of claim 2, wherein the left tab and panel guide member and the left hold down member is provided on one side of a conveyor path for a sequential array of conveyed boxes having opposed ends each with a tab and a panel and the right tab and panel guide member and the right hold down member is provide on another side on the conveyor path.

4. The box tab and panel folding and closing machine of claim 3, wherein the left tab and panel guide member and the left hold down member are provided in mirror symmetry relative to the right tab and panel guide member and the right hold down member.

5. The box tab and panel folding and closing machine of claim 4, wherein a left panel guide slot of the left tab and panel guide member is provided in mirrored symmetry relative to a right panel guide slot of the right tab and panel guide member configured to close opposed ends on a straight tuck (ST) box.

6. The box tab and panel folding and closing machine of claim 3, wherein the left tab and panel guide member and the left hold down member are provided in rotational symmetry relative to the right tab and panel guide member and the right hold down member.

7. The box tab and panel folding and closing machine of claim 6, wherein a left panel guide slot of the left tab and panel guide member is provided in rotational symmetry relative to a right panel guide slot of the right tab and panel guide member configured to close opposed ends on a reverse tuck (RT) box.

8. The box tab and panel folding and closing machine of claim 3, further comprising a final closer block configured to retain together the left tab and panel guide member and the right tab and panel guide member.

9. The box tab and panel folding and closing machine of claim 1, wherein the tab and panel guide member comprises a lower guide block and an upper guide block, the tab hold down member affixed to the upper guide block.

10. The box tab and panel folding and closing machine of claim 1, wherein the first tab progressively curved guide surface, the panel progressively curved guide surface, and the second tab progressively curved guide surface downstream of the first tab progressively curved guide surface each comprise a helical guide surface.

11. A tuck box closer, comprising:
a tab and panel guide member having an outer progressively curved tab guide surface configured to bend a tab relative to a contiguous panel on a box end, a progressively curved panel closing guide surface downstream at least in part from the slot, and a progressively curved tab tuck guide surface; and
a tab hold down member supported spaced from the outer progressively curved tab guide surface to define a slot between the tab hold down member and the outer progressively curved tab guide surface, the tab hold down member further spaced from an adjacent panel guide surface on the tab and panel guide member adjacent the slot configured to retain each box panel in a plane while the slot bends the respective tab relative to the plane along the tab guide surface.

12. The box tab and panel closer of claim 11, wherein the tab and panel guide member comprises a lower guide member and an upper guide member affixed to the lower guide member and a closer exit block affixed downstream to at least one of the lower guide member and the upper guide member, the closer exit block having a closer exit aperture configured to urge a folded and tucked tab and panel into a box opening to full close the tab and panel in a respective box.

13. The box tab and panel closer of claim 11, wherein a pair of left and right tab and panel guide members and tab hold down members are provided spaced apart to close opposed ends of a box and are joined together at a downstream end by a closer exit block having an exit aperture.

14. The box tab and panel closer of claim 13, wherein the left tab and panel guide member, the right tab and panel guide member, and the closer exit block form an immovable closer assembly.

15. The box tab and panel closer of claim 14, wherein the tab guide surfaces, the panel guide surfaces, and the tab tuck surfaces are polished surfaces.

16. The box tab and panel closer of claim 15, wherein the polished surfaces comprise a low friction surface coating.

17. The box tab and panel closer of claim 11, wherein the tab hold down member is removably affixed to a top portion of the tab and panel guide member with a plurality of threaded fasteners.

18. The box tab and panel closer of claim 17, wherein a laterally outward vertical side of the tab hold down member cooperates with the outer progressively curved tab guide surface to form a tab bending slot.

19. The box tab and panel closer of claim 18, wherein the tab hold down member further comprises a relief slot configured to provide tucking clearance for a tab being folded relative to a respective panel.

20. The box tab and panel closer of claim 11, wherein the tab and panel guide member and the tab hold down member are configured together as a unitary block.
